(19) United States
(12) Patent Application Publication
(10) Pub. No.: US 2020/0265351 A1
(43) Pub. Date: Aug. 20, 2020

(54) DATA SIMILACRUM BASED ON LOCKED INFORMATION MANIPULATION

(71) Applicant: Chainworks, Inc., Naperville, IL (US)

(72) Inventor: Tandon Rohit, Naperville, IL (US)

(21) Appl. No.: 16/278,203

(22) Filed: Feb. 18, 2019

(51) Int. Cl. G06Q 10/06; G06F 9/54; H04L 29/08; G06F 11/30; H04L 9/32; G06F 16/2457

(52) U.S. Cl. CPC G06Q 10/067; G06F 9/546; H04L 67/1093; G06F 16/2457; G06F 11/3082; G06Q 10/06315; H04L 9/3263; G06F 11/3006

(57) ABSTRACT

A system and process for simulating providing access to data that has been locked in a series of secured, sequential blocks. A listening station monitors data and signals the passage of structured transaction data, which is aggregated for the unpackaging of structured transaction information into discrete component information. The present invention makes available component information as unlocked, queued data distributed throughout a network of computing entities. The queued data is an emulation of the structured transaction information as would be found locked in any of the secured blocks, present and prior.

### FIELD OF THE INVENTION

The present invention relates to the field process design and more specifically to the field of supplemented data storage.

### BACKGROUND

Blockchain and Distributed Ledger (DL) are revolutionary technologies that enable business transactions between multiple organizations in a secured manner without the need of a centralized authority. The technologies ensure that each organization has the same copy of the log of business transactions (ledger), thereby establishing trust between organizations who can then transact without fear of repudiation.

In blockchain, transactions are grouped into a unit of storage called a block and the ledger is structured as secured linked list of blocks. On a finer level, blockchain can be further subdivided into two broad categories, public blockchain and private blockchain. Public Blockchain runs in a peer-to-peer (p2p) ecosystem where anyone one can join the blockchain. There are specialized peers in network, known as miners who run a consensus mechanism to decide the finality of a transaction. Private blockchain is where a business organization and its counterparty organizations form a network. The organizations in a private blockchain know each other. The key distinction is that in a private blockchain, peers must be granted cryptographic identities to access data in the network.

### SUMMARY

The present invention is directed to a data simulacrum system and process. The system and process include a distributed ledger environment having a network of computing entities generating structured transaction information. The entities include processing and storage adapted to allow each entity to (i) register as a peer node; (ii) communicate and distribute the structured transaction data among the computing entities; (iii) designate a tabulating computer for receiving a data flow comprising of a closed set of the structured transaction information; and (iv) lock the structured transaction information into a present secured block, linearly and chronologically positioned subsequent to a prior secured block, and having attributes of the prior block as a key.

The present invention includes a listening station, positioned to monitor the data flow as it is transmitted throughout the distributed ledger entities. The listening station both listens and is adapted to signal the passage of the structured transaction data. The signal from the listening station is received by an aggregator. The aggregator is adapted to unpackage the structured transaction information into discrete component information and write the component information as unlocked, queued data distributed throughout the network of computing entities. The queued data is an emulation of the structured transaction information as would be found locked in any of the secured blocks, present and prior. The aggregator may be either a transactional aggregator or an agnostic aggregator; the transactional aggregator suited to ascertain the raw information within the structured data for output related to the transaction, and the agnostic aggregator suited to provide information concerning the structured data, irrespective of the information within.

These aspects of the invention are not meant to be exclusive. Furthermore, some features may apply to certain versions of the invention, but not others. Other features, aspects, and advantages of the present invention will be readily apparent to those of ordinary skill in the art when read in conjunction with the following description, and accompanying drawings.

### BRIEF DESCRIPTION OF THE DRAWINGS

FIG. 1 is a view of a blockchain environment of the present invention.

FIG. 2 is a view of an ecosystem of the present invention.

FIG. 3 is a view of an ecosystem of the present invention

FIG. 4 is a view of an ecosystem of the present invention

FIG. 5 is a view of the system of the present invention.

FIG. 6 is a view of the system of the present invention.

FIG. 7 is a view of an ecosystem of the present invention.

FIG. 8 is a view of an ecosystem of the present invention.

### DETAILED DESCRIPTION

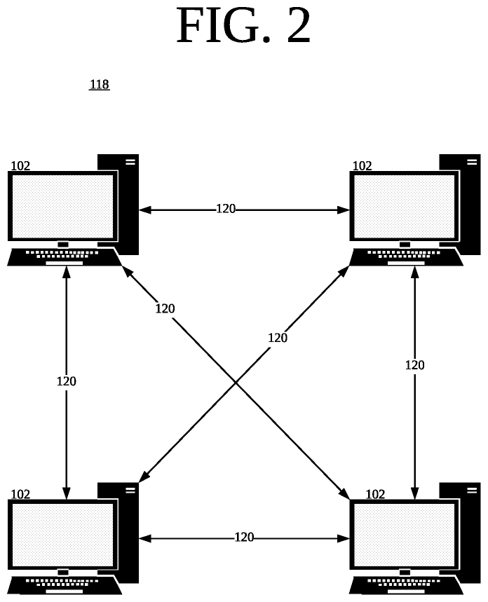

Referring first to FIGS. 2-6, a basic embodiment of the system 100 of the present invention is shown. The system includes a distributed ledger environment 118 having a network of computing entities generating structured transaction information. The entities include processing and storage adapted to allow each entity to (i) register as a peer node; (ii) communicate and distribute the structured transaction data among the computing entities; (iii) designate a tabulating computer for receiving a data flow comprising of a closed set of the structured transaction information; and (iv) lock the structured transaction information into a present secured block, linearly and chronologically positioned subsequent to a prior secured block, and having attributes of the prior block as a key. The entities are accordingly described according to common equipment, typically computers, however any electronic device capable of signaled transmission of communication may be used in accordance with the present invention. More scaled-down devices may be utilized with the present invention, often referred to as data sinks.

One thing is certain, data is growing rapidly, and within these massive data sets is information for better business and technical processes. Hadoop is an open source framework overseen by Apache software foundations for the storage and processing of large data sets. Hadoop uses Hadoop Distributed File System (“HDFS”) to store large quantities of data across a network via discrete entity 102 hardware and maintains a distributed filesystem. By entity 102 of the present invention, it is meant, depending on context, the business or natural person utilizing a computer to access a network and the distributed ledger ecosystem 118 or the computing device utilized by the business or natural person to access the ecosystem 118. From the standpoint of the network, the person/business interacts through the computing device with the network making the division largely artificial. HDFS is the preferred system at the present to the drafting of this disclosure, and other similarly performing systems (or such other systems as achieve the results and advantages of the present invention) may be used. As example of a system that may permit similar functionality includes the MICROSOFT Sink Writer software and environment.

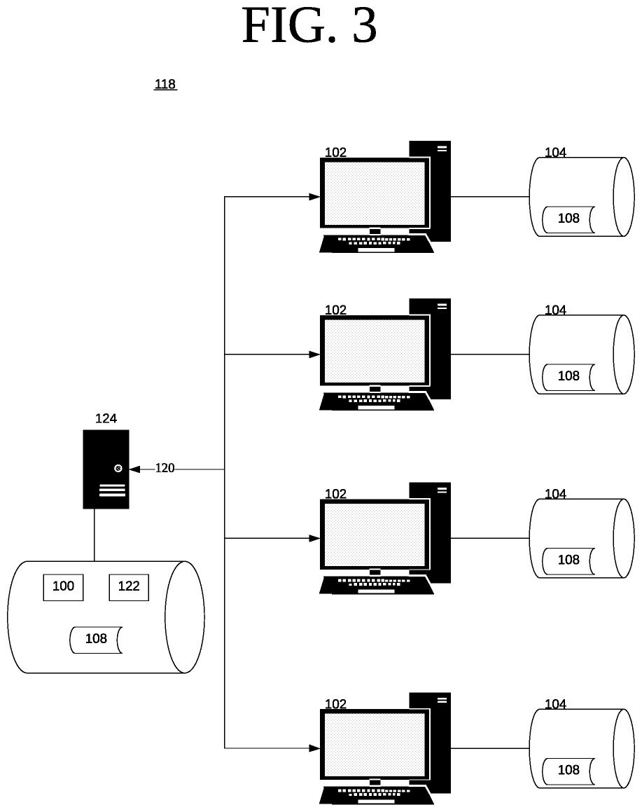

Hadoop stores data in a distributed and massively parallel computing environment and the files are scattered across storage 104 accessible to the discrete entities 102 of the ecosystem 118. HDFS is in central authority ecosystems 118 as depicted in FIG. 3 configured to have a Name Node entity 120 and a cluster of Data Nodes entities 102. This architecture is scalable and fault tolerant. The information may be split into data fragments and stored over the entities of the distributed ledger ecosystem 118. Since the data are distributed across different data nodes entities, instructions regarding data manipulation, such as writing, storage, and retrieval is maintained in an organized, centralized manner. The information regarding the distribution of data, block size, replica maintenance is kept in a file called metadata. The metadata is maintained in a specially designated, reliable hardware known as the Name Node Entity. Each fragment, preferably stored as a block of data, maintains a replication factor, by default 3, as a backup mechanism. The data block size is usually expanded to 64 MB or 128 MB. HDFS differs from the other distributed file system by the way of fault tolerance, by maintaining three replicas on each block.

HDFS is mainly designed to store the large quantities of data for extremely rapid computation on a cluster of Data Node entities and the files in HDFS are managed in certain ecosystems by a single server, the Name Node entities. Name Node entities store blockchain creation and retrieval data (“locking instructions”), such as metadata, in its main memory, for each file stored into HDFS. Consequently, HDFS suffers performance degradation with increased number of small files. Storing and managing a large number of small files imposes a heavy burden on the Name Node entity.

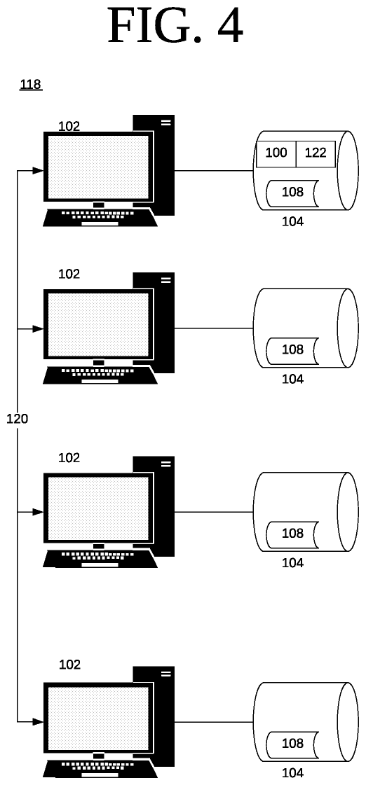

A primary advantage of HDFS is that the components of HDFS can be cheap commodity hardware for actual data storage in the Data Node entities and the whole data distribution, management and block creation, metadata creation are authorized and controlled by the single, expensive server known as Name Node entity. It is wise to utilize premium equipment as the Name Node entity as all of the Data Nodes rely thereon for operation and successful retrieval of data. The workload increases for the Name Node entity when large quantities of smaller files are to be stored and the problem was resolved using the introduction of a wholly decentralized distributed ledger ecosystem as is shown in FIGS. 2 and 4. The present invention ideally works with the decentralized distributed ledger, however, use of the present invention on a centralized distributed ledger is contemplated. When huge amount of data is to be processed, elimination of Name Node entity is difficult.

The decentralized HDFS is designed to store large quantities and volumes of data blocks for user applications. When it is required to store information exceeding Terabytes under big data technologies, the HDFS architecture is efficient, with a network that can be composed of thousands of Conventional Off-the-Shelf (“COTS”) hardware. The HDFS is for storing the data sets in any form, i.e. structured, semi-structured and unstructured. Decentralized HDFS achieves the objects of simplified, fault-tolerant storage with clusters of COTS hardware and with streaming access patterns with write-once-read-many strategy.

The HDFS can be conceptualized as roughly two architectural components. The first architectural component is the Name Node entity. The HDFS network distributed ledger ecosystem 118 includes, ideally, a single Name Node, a master server that manages the locking instructions 122 which provides all access, retrieval, and writing to and of files by clients. The Name Node entity is responsible for keeping track of the complete file system by dividing the locking instructions into at least two subparts: Name Space Image and Edit Log. The Name Space Image contains the metadata about the files and directories and it contains data about all the data blocks, the data nodes with which they are associated, and where data can be found in relation to the datanode entity itself. Editlog contains the log of activities on HDFS performed by any client. Editlog grows in relation to the activities that a client performs with respect to the HDFS.

Block information is updated by the Name Node entity as and when a Data Node entity joins the distributed ledger ecosystem 118. As soon as the Data Node entity boots up and connects to the network across which the distributed ledger ecosystem is housed, the Data Node entity should send the Name Node the following: metadata about the blocks possessed by it and the Name Node entity updates information to NameSpace Image. When a client requests storage on the distributed ledger ecosystem, this request is sent to the Name Node entity, which creates the corresponding metadata. The metadata may include the original file name, block filenames, and file size for each block, address of the Data Node entity and the address of the Data Nodes entities on which the multiple replicas are to be stored. The data once written cannot be altered, since it follows write-once-read-many architecture. The subsequent updates, if any, will be kept as separate data and all the transaction logs are maintained in the Editlog. The existence of single Name Node entity in a cluster greatly simplifies the architecture of the ecosystem 118, but the chance of single point of failure increases. When the client request storage of large quantities of data, the data is divided into blocks of 64 MB and each block is distributed to different Data Node entities within the cluster and the metadata is stored in Name Node entity. Alternatively, if small amounts of data are transmitted, the Name Node entity will wait and aggregate the data until an amount appropriate for storage is achieved—or based on some other factor. The Data Node entities periodically send a heartbeat to make the Name Node entity aware of their existence. The Data Node entities may also send a block report to the Name Node entity after storage of data blocks. Receipt of the periodic heartbeat implies that the Data Nodeentity hardware is functioning properly. A block report acknowledges the receipt of the data blocks by the Data Node entities. The NameNode entity keeps the repository for all HDFS metadata. The system is designed in such a way that user requests through the Name Node into HDFS storage.

The second architectural component is the Data Node entity. Data Node entities are cheaper COTS hardware with storage and processing capability which are grouped across different clusters. HDFS exposes a file system namespace and allows user data to be stored in files. The input file is split into a number of files blocks (e.g., blocks of 64 MB or 128 MB) and the blocks are stored in a set of Data Nodes as per the metadata information from the Name Node entity. The Name Node entity executes file system namespace operations like opening, closing, and renaming files and directories. It also determines the mapping of blocks to Data Node entities. The Data Node entities are responsible for serving read and write requests from the file system's clients. The Data Node entities also perform block creation, deletion, and replication upon instruction from the Name Node entity. When a Data Node entity starts up, it ideally scans through its local file system, generates a list of all HDFS data blocks that correspond to each of these local files and sends this report to the Name Node entity, which is the block report. All of the Data Node entities should periodically transmit heartbeats to the Name Node entities for purposes of maintaining the ecosystem.

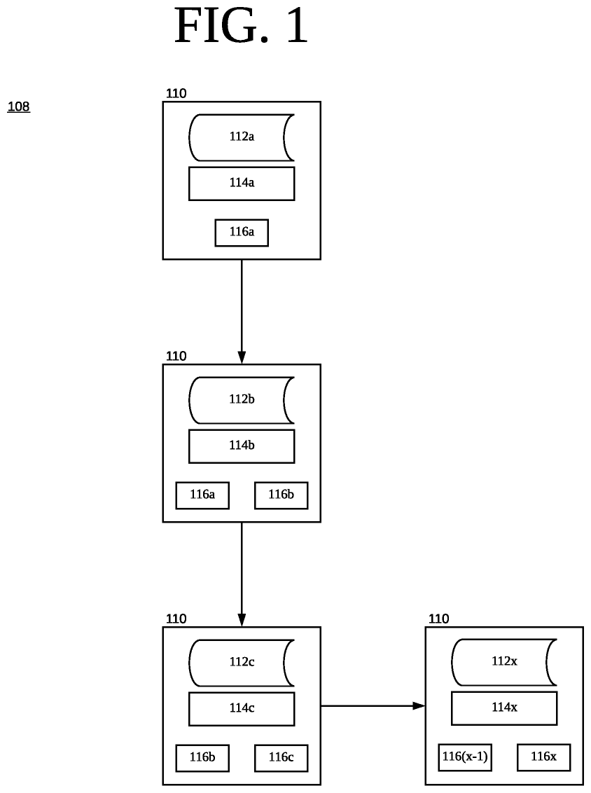

The working principle of HDFS follows a master-slave configuration. Master services include Name Node entities, secondary Name Node entities and job tracker and the slave services include Data Node entities and task tracker. The master node and slave nodes can communicate with each other, with the slave nodes following the initiatives set by the Master nodes. The slave nodes communicate with each other. The job tracker can communicate with the Task Tracker as depicted in FIG. 1.

HDFS architecture is a distributive storage mechanism and it differs from other distributive systems with a better fault tolerant mechanism and an efficient replica management. The characteristics of the HDFS architecture that contribute to its advantages are many. A first advantage of the HDFS architecture is its ability to compensate for Name node and Data Node failures. Hardware failure may occur in the central Name Node, distributed DataNodes, or both. Data recovery from the last checkpoint, which can be stored in a remote NFS mounted file, is handled by secondary Name Node. The unreachability of data due to the failure of data nodes entities is further compensated by maintaining duplicate copies in other Data Node entities across the ecosystem.

A second characteristic of the HDFS ecosystem is the concept of “write-once-read-many” activities. For the security of data which is distributed across a cluster of node entities, HDFS applications apply a write-once-read-many access model for files. A file once created as a block, is written and closed, and need not ever be modified—even in response to a future alteration of prior information. Instead, the augmented/modified information is applied to a later block, merely noting the replacement of the information, rather than erasing the existence of the now-outdated information. Because consistency of data is difficult to maintain in a distributed architecture, this write-once-read-many schema, coupled with the mass duplication of bocks, simplifies data coherency issues and easy data access.

A third characteristic of the HDFS ecosystem is the idea that computation is moved to the data, rather than moving the data to computation. The concept is particularly applicable to the preferred process 100 of the present invention when applied to the decentralized ecosystem 118 of FIG. 4. Because there is an absence of a name node, locking instructions 122 and accordingly any subprocesses related to the present invention may be shunted around to whichever entity 102 assumes the duty of the locking instructions 122 to create locked blocks of data, etc. In the creation of data blocks, to determine which of the data node entities 102 will assume the block creation duties, the entities will often ‘bid’ to see which entity is the most fit for the creation of the block, which may include: amount of activity, strength of processor, storage space present, etc. In HDFS, a computation requested by an application is much more efficient if it is executed near the data it operates on. This is particularly the case when the amount and quantity of data is sizable. Relocating the computation rather than the data minimizes network congestion and increases the overall throughput of the ecosystem. HDFS provides interfaces for applications to move themselves closer to where the data is located.

As a fourth characteristic of HDFS is its portability. HDFS has been designed to be easily portable from one platform to another. This facilitates widespread adoption of HDFS as a platform of choice for a large setoff applications. Shrading enables the expansion of servers within the network entities, which is readily accomplished, because the HDFS architecture is designed for hardware and software portability.

The major drawback of the centralized ecosystem architecture is that the existence of central Name Node leads to single point failure. Another issue is that the entire workflow in centralized HDFS architecture is that it is based on metadata residing on a single entity, and it is possible that a block of data shunted between node entities arrives corrupted. This corruption can occur because of faults in a storage device, network faults, or software errors. The HDFS client software implements protection mechanisms, usually checksums, on the contents of HDFS files. When a client retrieves the file contents it verifies that the data it received from each Data Node matches the checksum stored in the associated checksum file. If not, then the client looks to another node to retrieve the block, which is a replica of the corrupted block.

Turning now to FIG. 1, a blockchain is a distributed database of records or public ledger of transactions or digital assets which is executed and shared among the authorized set of users. The blockchain schema is based on creating new blocks via a distributed consensus that allows the peer nodes on the network and the users of the blockchain to trust that a digital event or record has been created and unchanged since creation. A block for the present invention is a conceptual self-contained discrete unit of data entries bearing its own security mechanism, here as a hash, that would be invalidated if a any of the data entries were modified. A secondary characteristics, which may or may not be applicable to the present invention, depending on how the invention is applied, is establishing anonymity. The blockchain in its locked states is capable of hiding the identity of the parties in the ecosystem or even the party that created the now locked and secured information. Blockchain technology has specific applications in both financial, e.g. bitcoin, and various other industries/sectors. Each blockchain transaction is verified and broadcast to every other node entity in the ecosystem.

Information held on a blockchain 108 exists as a shared and continually reconciled database between the peer nodes. When the term “peer node” is used in the present disclosure, it is meant any node entity that either supplies or receives information within the ecosystem for creation of a locked, sequential block data chain. The blockchain database is not required to be stored in any single location, and because the records within the blockchain 108 can be public, the veracity of the blocks is verifiable. In the decentralized ecosystem, no centralized version of this information exists for a hacker to corrupt. For public blockchains, which are hosted by millions of computers simultaneously, the data is accessible to anyone on the internet.

The blockchain 108 is composed of individual blocks 110. Each block includes at least four components, excepting the first or genesis block, which only includes three of these elements. Each block includes the structured data 112a, 112b, 112c, 112x of the block, the timestamp 114a, 114b, 114c, 114x, the hash of the block 116a, 116b, 116c, 116x, and the hash of the prior block 116a, 116b, 116(x−1). Each block 110 of the blockchain 108 points to the blocks prior and subsequent to it, and/or the chain data is held in a centralized Name Node entity as metadata. These blocks may be cryptographically locked such that the structured data 112a within cannot be accessed, or that the computational power necessitated by accessing the block chain makes accessing it impractical and cost-prohibitive. Furthermore, because blocks within the blockchain are meant to be immutable, later modifications to information within a block can only be applied to a later block. Thus, an inquiry into the information of a block may require a forward and backward search to ratify the constancy of the information found.

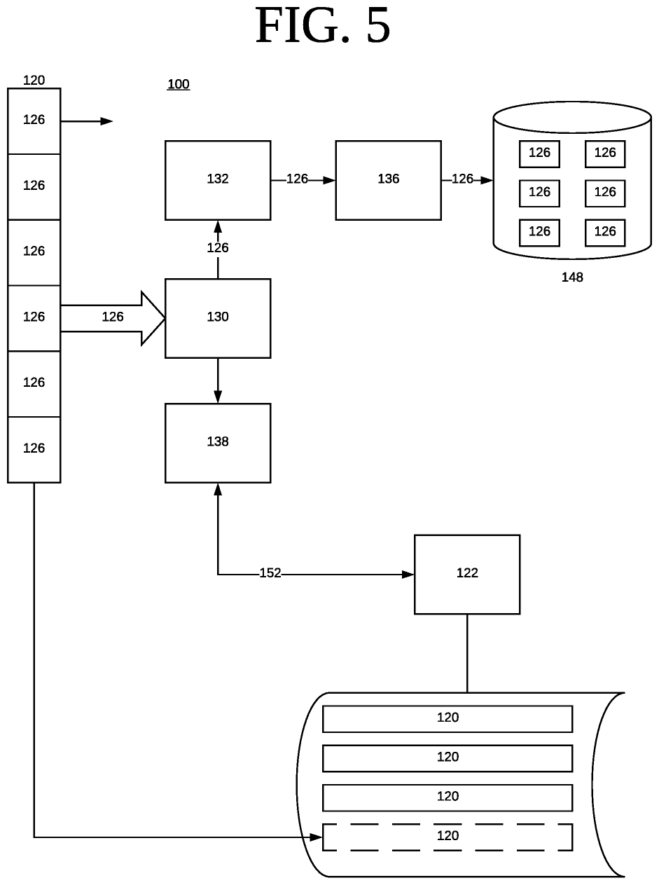

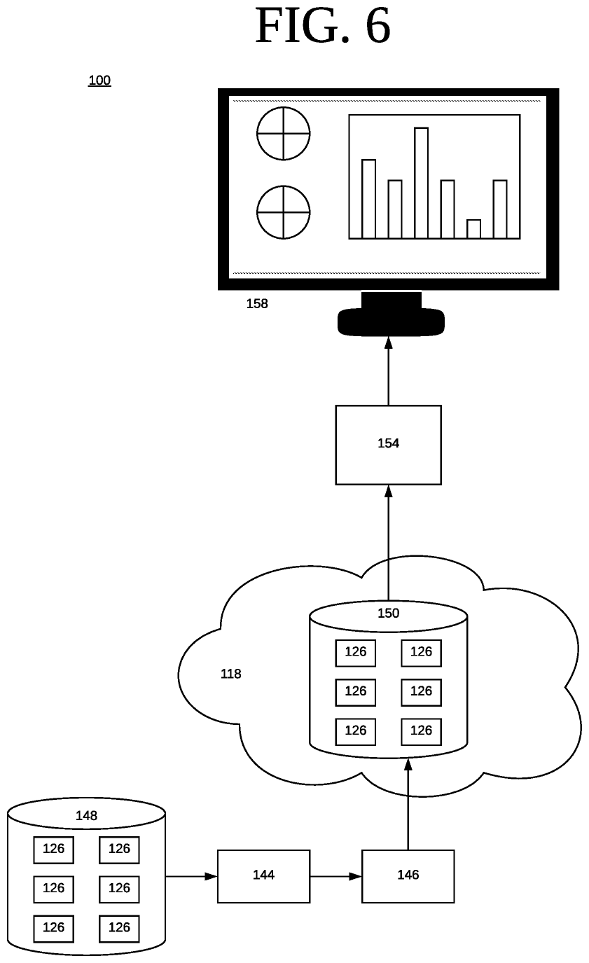

Turning now to FIGS. 5-6 of the present invention, the system 100 is depicted during the creation of a blockchain structure. Information 126 is acquired as raw data from one or more programs. By information or raw data or raw information, it is meant the information that is output or input into a software program. An example of raw information placed into a program may be the price of shrimp in Alabama, the time to transport refined petroleum from Louisiana, or the payment date for a transaction. This raw information 126 is then processed into structured data 120 that contains both the information as well an indication of its purpose. Structured data 120 may typically include an indication of category, e.g. “price”, or “time”, or “date” rather than the specific quantities themselves. Structured data may include other structuring applied to the data, such as TCP/IP data that indicates the position of the information within data packets.

The structured data 120 is transmitted via data flow between two node entities 102, 120 and arrives at the destination where it is to be locked with the locking instructions 122 of the present invention. The system 100 includes a listening station 130 positioned to intercept and monitor the data flow as it is shunted from node-to-node or between the subprocesses of the blockchain formation on the virtual machine adapted to create the blockchain. The listening station 130 may register itself with the blockchain ecosystem 118, and preferably imitates a node, including presenting such credentials as a node may present to validate its access to the data flow. Whenever any transaction happens, blockchain will notify the listening station takes the services of a queue writer to write the information 126 of the structured data 120 or the structured data 120 as it bears the information 126 to the queue 148.

Prior to access by the queue writer 136 or queue reader 144, the information 126 or data structures 120 are first aggregated by the aggregator 132, 138. The aggregator of the present invention is preferably managed in two separate aggregators, the transactional aggregator 132 and the agnostic aggregator 138. The transactional aggregator 132 aggregates structured data and information from the contents of the data flow, e.g. price, times, and names, etc. The agnostic aggregator 138, however, is agnostic to the information contained within the structured data and instead provides guidance 152 to the locking instructions 122 concerning when, how, why, or where to lock the structured data and information into blocks.

The agnostic aggregator performs analysis that pertains to the state of blockchain system itself and is performed in real time as well as in historical mode. It answers questions like: quantity of transactions happening in system now or in a given interval, current rate of block creation, average number of blocks created in system in a given interval, maximum time between two blocks in a given interval, who is doing maximum transactions in a given interval, the most happening transaction in a given interval and so on. The Aggregator provides following benefits to the organizations.
Help organizations to plan the capacity of systems and allocate appropriate resources to different components of system
Help organizations to verify the claims of a party in case of dispute
Help organizations to analyze the business growth with counterparties and classify the counterparties as gold, silver etc.
Help organizations to identify any abnormal behavior on network e.g. increased no of transactions on a holiday
Help organizations to identify popular products, e.g. wire transfer, and thereby providing a valuable insight into customer behavior
Helps organizations to comply with regulators by producing reliable, reproducible reports based on immutable records
Helps organizations to audit the system of record
Helps organizations create a system of alerts triggered by network or business events
Help organizations to track suspicious transactions or detect anomalies in financial transactions
Help organizations in harnessing (to integrated into Enterprise Data Warehouse) the blockchain network transactions which otherwise are locked up in the network database
Help organizations in harnessing the blockchain network transactions for integration with Enterprise Resource Planning Software(s) (ERP's)

The agnostic aggregator takes this information and provides it to the locking instruction mechanism 122 for evaluation of modifications of locking, e.g. more frequently, in larger data files (e.g. from 64 MB to 128 MB). The transactional aggregator stores the state of business transactions in HDFS in a structure that either retains or is calculated to mimic or translate the business data model as contained in the information in the structured data. As end users are well versed with business data model and HDFS is an open system, this data can be easily accessed for further analysis using: any BI tool; SQL Queries; Out of the box Rest APIs

From the aggregator, or as part of the aggregator, the queue writer writes transactions to the queue 148. Then a queue reader 144 reads transactions from the queue. An HDFS writer than writes the information into the HDFS ecosystem 118. This system may be locally contained or part of a cloud or other means of data storage. An analytical engine 154 reads data from HDFS, performs various transformations and prepares data for visualization in the visualization engine 158, that renders data to user via an intuitive a display output.

### Example

Now, it is presented an example of how the present invention interfaces with a popular private blockchain network called Hyperledger Fabric. In this example, there may be a private blockchain with a few key components:

1. Ordering Service Node—aggregates and orders transactions into blocks and sends these blocks to the peers in the network

2. Peer Chaincode Container—A virtual machine that runs the chaincode (“smart contract”) for a single peer in the network

3. CouchDB State Database—A virtual machine which runs a CouchDB database and keeps track of the current “state” of that peer's blockchain

4. Peer Certificate Authority—Each peer in the network will run a Certificate Authority node that interfaces with the master certificate authority for identity management in the blockchain ecosystem

5. Peer Node—the virtual machine which actually participates in the blockchain network. This may run inside a particular company alongside the company's other peer nodes that participate in the network

The invention highlighted in this document uses the Hyperledger Fabric Node (javascript) Software Development Kit to interface with a specific running network based on administrator-defined configuration information. The Connection Manager will use this configuration data to determine what type of chaincode is running and how to connect as a node in the network. Once the Connection Manager has successfully authenticated via provided X509 certificates, it uses the SDK to connect to each “channel” in the private blockchain network and receive transactions from the peers that are authenticated with this particular channel. Once connected, the module listens for new transactions and performs various data permutations on the transactions before relaying them through to Queue via Queue Writer. Eventually, transactions will reach HDFS big data store where Analytical Engine will process them and prepare info for presentation to User.

The present invention allows access to information stored within secured blocks without the necessity of searching with the blocks. Among the reasons that doing so might be a significant efficiency upgrade is that, although blockchains are strong indications of data reliability, they are computationally heavier than overwritten ‘current’ data. Current data within a database may represent the state of the information contemporaneous to the request for the information and represents a relatively certain expression thereof. Information retrieval from such a database is simple and obviates the need for forward (in time) and backward (in time) searches for data that replaces or supplements the same. Retrieval of information contained within a blockchain further necessitates, in a numerous use-case instances, a forward search for replacement/supplementation of that information (and perhaps a backward search for pre-existing data for contextual or other reasons. The present invention may utilize the simulacrum of the present invention for the retrieval or review of data, whereby the blockchain is only searched to validate the simulacrum data in specific instances. These specific instances may include: suspiciousness of simulacrum data, corruption of simulacrum data, frequent and/or suspicious access of simulacrum data, and the like. Therefore, the present invention can supply the computational lightness of a simplistic database coupled with the security and accuracy of a locked, sequential database.

In other use-cases, the present invention may not allow end users access to the data simulacrum at all, and the simulacrum exists for the purposes of administrative efficiency. Furthermore, in other embodiments the data simulacrum may be available to one class of users (e.g., unsecured users or free users) while the data as verified by blockchain may be available for a greater class of users (e.g., users bearing certain credentials or commercial users).

Examples of uses of the present invention include facilitating international retail banking between a consortium of several banks. As the banks transact, the transaction details are stored in Ledger in a proprietary format. With vanilla blockchain implementation, there is no way for an end user to properly analyze the traffic, to know rate of transactions, which two banks are transacting the most, which type of transactions (e.g. wire transfers) are happening the most, or at what time more transaction happen. The present invention equips bank users with access to that analytical aggregated information. Banks can better plan the capacity of their system, can gain insight into the popularity of products, can launch similar products and detect any abnormal behavior.

In a supply chain industry, a shipment company may collaborate with a retailer on a shared ledger. Each shipment is recorded on a ledger, truck progress is logged on a ledger and shipment arrival is recorded by a retailer on a ledger. With a basic blockchain implementation, there is no easy way to match the two transactions, except manually, whereas such match is critical to determine if each shipment had actually reached the destination. The present invention allows both shipment company and retailer to build an analytical application to track the movement of goods in real time, slice and dice historical records to discover failures and opportunities for optimization and run all kinds of management and decision support reports.

In a the food and hospitality industry, food provenance emerged as a “classic” case for ledger implementations. With such approach, every transaction associated with the food ingredients, food packaging, food transfer and food sales is stored on a Ledger along with its metadata, such as composition of a complex product with the list of its ingredients. The present invention allows a user to create a system of alerts to monitor certain sales anomalies, pinpoint growth areas and determine the affected customers/stores in the face of a food recall.

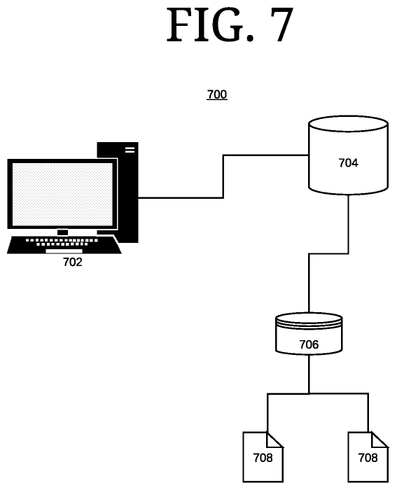

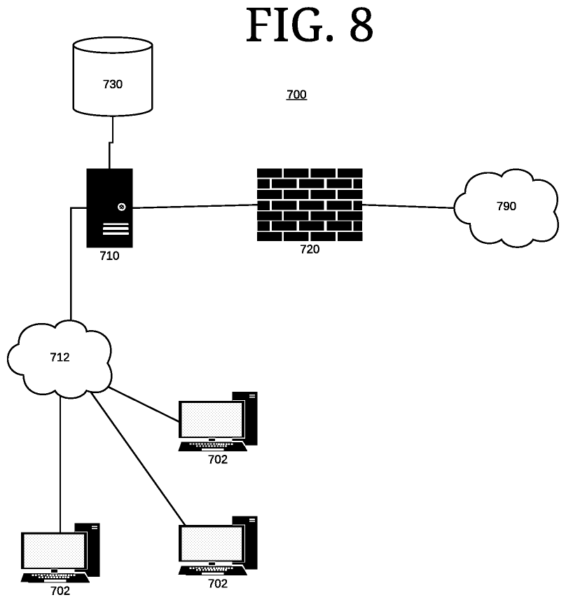

FIGS. 7-8 depict a computer ecosystem 700 of the present invention. By ecosystem it is meant one or more computers 702 that are organizationally related. The ecosystem may include computers under common ownership, computers that belong to the same network or series of networks, computers that are collaborating, etc. The present invention may be provided as a computer program product, or software that may include a computer-readable storage medium 704 having stored thereon instructions, which may be used to perform the process of the present invention across a computer ecosystem 700 according to the various embodiments disclosed herein.

A computer 702 of the present invention may include any combination of one or more computer readable media 704. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium 704 may be any tangible medium that can contain, or store a program for use by or in connection with an instruction execution system, apparatus, or device.

A computer readable signal medium 704 may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures described below illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Furthermore, the functionality of one block may be subsumed by the functionality of another block as a substep thereof. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

An ecosystem 700 may further include a computer network or data network that allows computers to exchange data. In a computer network of the present invention, networked computing devices pass data to each other along data connections. The connections between nodes are established using cable media, wireless media, or other media. The Internet or other exterior network 790 may be a component of the ecosystem 700. Nodes may include hosts such as personal computers, phones, servers, and networking hardware. Two such devices are networked together when one device is able to exchange information with the other device, whether or not they have a direct connection to each other. Computer networks of the present invention support applications such as access to the World Wide Web, shared use of application and storage servers, printers, and fax machines, and use of email and instant messaging applications. Computer networks may be included irrespective of the physical media used to transmit their signals, the communications protocols to organize network traffic, the network's size, topology, and organizational intent.

It is preferred that the network of the present invention has at least one boundary 720, and potentially multiple boundaries if a demilitarized zone is utilized. The boundary 720 may include any number of layers designed to regulate and secure the flow of information between networks. Boundary layers of the present invention may include enterprise content management software, firewalls, filters, threat management software, alarms, etc. Software for establishing a boundary may be run on a server 710 with server storage 730 of the present invention, which may include directory services controlling access credentials.

To combat security risks posed by network connections, firewalls are frequently used. A firewall may be a hardware or software component that filters network traffic so that communications with unauthorized third parties are blocked but legitimate network functions may be carried out. Frequently, the filters applied by a firewall are specified by a set of policies defining characteristics of network messages that either should pass through the firewall or that should be blocked. Because different levels of communication may be appropriate depending on the origin or destination of messages, firewall policies may be provided for each application that executes on a computing device and communicates over a network.

A firewall may have an outward side facing a global network, such as the Internet. The opposite side of the firewall may be a private network that is protected by the firewall. The private network may include any number of host machines (e.g., computers) each addressable by its own IP address. The physical construction of the network may be such that all data packets intended for one of the IP addresses behind the firewall pass through the firewall. Using the firewall rules, which may be set by a network administrator or other user, the firewall may determine whether to allow or deny certain data packets and/or determine where to route particular data packets based on the IP addresses to which the packets are directed. The determination of where to route data packets may be done using the IP addresses of the host machines in the private network.

Depending on the addressing scheme used by the network, the IP addresses of the host machines may be static or dynamic. Static IP addresses do not change over time, and thus once they are set in the firewall rules, there is no need to update them. The Internet Protocol version Four (IPv4) addressing system commonly uses static addressing, while IPv6 may use dynamic addressing. Dynamic IP addresses may change over time and thus, there is a need to update the firewall rules as changes occur. When a small Local Area Network (LAN), such as a domestic network in a private residence, is linked to a larger network such as the Internet, the link is often through a gateway router acting as a firewall. One of the functions of the firewall is to protect the LAN from intrusion from outside.

A service directory accessible by a server 710, usually on server storage 730, stores information about network resources across a domain. An example of a directory service is Active Directory. The main purpose of Active Directory is to provide central authentication and authorization services for Windows-based computers. Active Directory also allows administrators to assign policies, deploy software, and apply critical updates to an organization. Active Directory stores information and settings in a central database.

An Active Directory structure is a hierarchical framework of objects. The objects fall into three broad categories: resources (e.g. printers), services (e.g. e-mail) and users (e.g., user accounts and groups). The Active Directory provides information on the objects, organizes the objects, controls access and sets security. Certain objects can also be containers of other objects. An object is uniquely identified by its name and has a set of attributes—the characteristics and information that the object can contain—defined by a schema, which also determines the kind of objects that can be stored in the Active Directory.

Typically, the highest object in the hierarchy is the domain. The domain can be further sub-divided into containers called Organizational Units. Organizational units give a semblance of structure to the organization either based on administrative structure or geographical structure. The organizational unit is the common level at which to apply group policies, which are Active Directory objects themselves called Group Policy Objects. Policies can also be applied to individual objects or attributes as well as at the site level (i.e., one or more IP subnets).

The present invention may use one of more communication networks to foster information exchange throughout the computers of the ecosystem. Communication networks might either be private or public. In a private network, communications between multiple computers occur in a secure environment that prevents access from outside the network without appropriate authentication. These networks are considered as “trusted” networks because the communication signals securely travel from one computer to another within the private network without being exposed to the external environment.

Public networks such as the Internet, on the other hand, are not secure because the communication over these networks is not private and is susceptible to interception by other computers. In addition, the public networks cannot guarantee the delivery of the data packets being sent. They allow packets to be injected into, or ejected out of, the networks indiscriminately, and analyzed while in transit. To keep data sent over a public network private, a Virtual Private Network (VPN) is commonly established on top of a public network when two computers use the public network to communicate with each other. In a Virtual Private Network, data sent from one computer to another is encrypted by a security gateway and transmitted in encrypted form over the public network to a second security gateway connected to the receiving computer. The second gateway decrypts the data before forwarding it to the receiving computer. Such a private channel established on top of another network is referred to as a network tunnel.

In order to set up a Virtual Private Network, a user first establishes a path to a VPN server and goes through an AAA process (Authentication, Authorization and Accounting) for identification and authorization to create a secure tunnel with the server. Once the user is authorized, a secure network tunnel is established between the user and the VPN server over the public network, using a VPN protocol such as IPsec. This process requires a VPN client on the user's side, a VPN server and other VPN hardware on the other side of the tunnel, as well as appropriate user configurations.

Today's private networks often include wireless networks such as WiMAX to accommodate mobile access. In addition, to provide mobility access in a large geographic area, a private enterprise often relies on third-party wireless infrastructures besides its own wireless network. In this case, a user's device would need to be authenticated by both a third-party gateway and an enterprise authentication server before it could access the enterprise network. User credentials are typically requested by and securely returned to the third-party gateway. Once the user is authenticated and authorized, the user may communicate with the third-party wireless gateway.

The present invention includes files 708, which may include executable instructions by which the present invention runs, or files upon and with which the present invention interacts. The documents may be on local storage 704 or shared storage 730 and be created, accessed, edited, and/or otherwise modified using any of a number of applications, including for example and without limitation Final Cut Pro, Avid, Microsoft Office applications (Word, Excel, Power Point, Outlook, Visio, etc.), Adobe Reader or Acrobat, AutoCAD, SolidWorks, or any other suitable document editing application. The content of the documents may be audio tracks, video clips, images, word processing documents, presentations, spreadsheets, business documents, engineering documents, databases, etc.

Although the present invention has been described in considerable detail with reference to certain preferred versions thereof, other versions would be readily apparent to those of ordinary skill in the art. Therefore, the spirit and scope of the appended claims should not be limited to the description of the preferred versions contained herein.

What is claimed is:

1. A locked information manipulation system comprising:
a distributed ledger environment having a network of computing entities generating structured transaction information adapted to (i) register as a peer node; (ii) communicate and distribute said structured transaction data among said computing entities; (iii) designate a tabulating computing entity for receiving a data flow comprising of a closed set of said structured transaction information and (iv) lock said structured transaction information into a present secured block, linearly and chronologically positioned subsequent to a prior secured block, and having attributes of said prior block as a key;
a listening station, positioned to monitor said data flow and adapted to signal the passage of said structured transaction data; and
an aggregator, adapted to receive data passage signals from said listening station, and unpackage said structured transaction information to into discrete component information and write said component information as unlocked, queued data distributed throughout said network of computing entities adapted to emulate said structured information as locked in any of said secured blocks, present and prior.

2. The system of claim 1 wherein said listening station imitates said peer node.

3. The system of claim 2 wherein said peer node registers by presenting a node certificate, and said listening station includes said node certificate.

4. The system of claim 1 wherein said communication of structured data occurs over multiple discrete channels, and wherein said listening station intercepts data flow spanning all of said multiple discrete channels.

5. The system of claim 1 wherein said aggregator includes an agnostic aggregator, adapted to generate circumstantial information concerning said data flow, and a transactional aggregator adapted to store substantive information concerning said structured transaction data.

6. The system of claim 5 wherein said distributed ledger locks said structured data subsequent to locking instructions received from said agnostic aggregator.

7. The system of claim 1 further comprising an analytical engine adapted, upon query from a user as to manipulate stored data, to primarily manipulate said queued data and present said queued data with a secondary check of said stored data represented by said queued data.

8. A locked information manipulation process:
distributing transactional data across a distributed ledger environment having a network of computing entities generating structured transaction information adapted to (i) register as a peer node; (ii) communicate and distribute said structured transaction data among said computing entities; (iii) designate a tabulating computing entity for receiving a data flow comprising of a closed set of said structured transaction information and (iv) lock said structured information into a present secured block, linearly and chronologically positioned subsequent to a prior secured block, and having attributes of said prior block as a key;
scanning said data flow via a listening station, positioned to monitor said data flow and adapted to signal the passage of said structured data; and
aggregating said data flow via an aggregator, adapted to receive data passage signals from said listening station, and unpackage said structured information to into discrete component information and write said component information as unlocked, queued data distributed throughout said network of computing entities adapted to emulate said structured information as locked in any of said secured blocks, present and prior.

9. The process of claim 8 wherein said distributing step includes distributing transactional data includes said listening station imitating said peer node.

10. The process of claim 9 wherein said distribution step includes registering peer node by presenting a node certificate, and presenting said node certificate by said listening station.

11. The process of claim 8 wherein said distribution step includes communicating said structured data occurs over multiple discrete channels, and wherein said listening station intercepts data flow spanning all of said multiple discrete channels.

12. The process of claim 8 wherein said aggregator includes an agnostic aggregator, adapted to generate circumstantial information concerning said data flow, and a transactional aggregator adapted to store substantive information concerning said structured transaction data.

13. The process of claim 12 wherein said distributed ledger locks said structured data subsequent to locking instructions received from said agnostic aggregator.

14. The process of claim 8 further comprising an analytical engine adapted, upon query from a user as to manipulate stored data, to primarily manipulate said queued data and present said queued data with a secondary check of said stored data represented by said queued data.
